(19) United States
(12) Patent Application Publication
(10) Pub. No.: US 2025/0258277 A1
(43) Pub. Date: Aug. 14, 2025

(54) A SYSTEM & METHOD OF SIMULATING RADAR GROUND CLUTTER

(71) Applicant: Leonardo UK Ltd, London (GB)

(72) Inventors: Calum MAITLAND-WARNE, London (GB); Alexander SPRAKLEN, London (GB); Ben HOPSON, London (GB)

(73) Assignee: Leonardo UK Ltd, London (GB)

(21) Appl. No.: 18/856,775

(22) PCT Filed: Apr. 17, 2023
(86) PCT No.: PCT/EP2023/059935

§ 371 Date: Oct. 14, 2024

(30) Foreign Application Priority Data
Apr. 15, 2022 (GB) 2205627.9

(51) Int. Cl. G01S 7/40; G01S 13/90

(52) U.S. Cl. CPC G01S 7/4052; G01S 13/90

(57) ABSTRACT

A method of simulating radar ground or sea clutter for testing and designing of radar by providing a terrain model including discrete flat ground patches each having a reflectivity, area, surface normal vector, and position within a global coordinate frame, calculating triplet values of reflected energy, range and Doppler shift for each discrete patch of the terrain model for a given position and pose of an antenna with known gain and phase characteristics within the global coordinate frame; and for a given radar receiver sample rate and Pulse repetition frequency (PRF), resampling and integrating over all patches through carrying out a 2D transformation using a non-uniform Fast Fourier Transform. The method can correct the lack of spatial correlation and increase the speed at which realistic ground clutter modelling can be generated.

Radar ground reflections also known as ground clutter returns, are a perpetual challenge for airborne radar. Ground clutter returns depend on terrain, platform pose, antenna steering, and the radiation pattern of both transmitter and receiver antennas. Pulse-Doppler radar allows targets of interest to be distinguished from ground returns by their Doppler shift, as well as range. However, the periodic nature of the pulse train creates ambiguity in the range, and possibly also Doppler shift, for both potential targets and ground clutter.

With the advent of array antennas and multi-channel receivers, techniques exist for the suppression of ground returns based on angle of arrival, such as Space-Time Adaptive Processing (STAP) and more general Adaptive Detectors. Real-world radar data is expensive to collect, and sets up a circular dependency between the design of the radar antenna and receiver, and the data collection. Therefore, realistic simulation of ground clutter is a desirable tool for the development of multi-channel radar systems.

A long-established approach to the simulation of ground clutter returns for airborne pulse-Doppler radar systems, herein referred to as the Iso-Range method, is to first choose a sample rate and pulse repetition frequency (PRF), which together define discrete range and Doppler ‘bins’ in the radar detector. These can then be projected onto a ground model, defining ground patches separated by the intersection of iso-range curves and iso-angle lines. Pulse-Doppler radar is generally ambiguous in range, particularly for high PRF (HPRF) modes. It may be ambiguous in Doppler too, particularly for medium PRF (MPRF) modes. This means that each range-Doppler bin receives power reflected from multiple separate ground patches whose boundaries are defined by the platform position and pose, as well as by the PRF and radar sample rate. The energy returned by each patch depends on the illumination angle, patch ground area, and material reflectance which may be generated statistically from a probability distribution, e.g. exponential or Weibull.

Ground patches defined in this way map unambiguously onto range gates, by construction. Although such patches are defined in terms of constant azimuth angle, an even split in angle does not map to an equal partition in Doppler. Therefore the contribution of one ground patch may affect multiple Doppler bins, and this interpolation is managed by first transforming to time-domain waveforms representing each pulse, and then applying Doppler compression. In this way, the spatial correlation between nearby Doppler bins is maintained.

However, by defining ground patches in terms of platform position and pose, it makes it difficult to maintain a consistent model for ground elevation and reflectance, which is particularly important for bi-static radar systems. It also means that long-term correlations for ground clutter are difficult to maintain, if these involve changes to platform position or pose, as required for ground-imaging applications like synthetic aperture radar (SAR).

A more modern approach to clutter modelling, herein referred to as the Fixed-Earth method, uses a fixed persistent model for the ground geometry and reflectance. This allows long-term correlations to be maintained, as well as providing an opportunity to separate transmitter illumination from the receiving antenna position and pose, necessary for modelling of bi-static radar.

A common approach across both Iso-Range and Fixed-Earth methods, is to model the ground as a discrete set of flat ‘patches’, compute the expected radar return from each using the radar equation, and then sum the contribution from every patch. How the methods differ is in how the ground patches are defined and in which domain this integration occurs.

Compared with Iso-Range method, the Fixed-Earth method attains greater processing speed improvement from running on a graphics processing unit (GPU). Additionally, it allows for simulation of clutter returns that are consistent over a flight path because the model does not need to be regenerated for changes in platform position, as such it enables ground clutter modelling for bi-static radar or SAR. Further, it is able to incorporate elevation and ground type information of real landscapes, e.g. obtained from third party data sets. A consequence of this is that simulated ground clutter can be compared with real-world flight trial data for accuracy.

However, a problem with using the Fixed-Earth model is the relationship between the boundaries of ground patches and receiver range & Doppler divisions is not simple. Ignoring this leads to a lack of spatial correlation and as such unrealistic ground clutter modelling compared with the Iso-Range method. The present invention was conceived to ameliorate this problem.

According to a first aspect of the invention there is provided a computer implemented method of simulating radar reflections from ground and/or sea clutter for a pulse-Doppler radar, the method comprising:
a) providing a terrain model comprising discrete flat ground patches each having a reflectivity, area, surface normal vector, and position within a global coordinate frame, that are all independent of view point;
b) calculating triplet values of reflected energy, range and Doppler shift for each discrete patch of the terrain model for a given position and pose of an antenna with known gain and phase characteristics within the global coordinate frame;
c) for a given radar receiver sample rate and Pulse repetition frequency (PRF), resampling and integrating over all patches to derive either:
   i) energy within each discrete range-Doppler pair bin of a set defined by the PRF and sample rate; and/or
   ii) receiver signal level at discrete time samples for each pulse;
d) characterised in that the resampling and integrating process comprises carrying out a first 2D transformation of the triplet values using a non-uniform Fast Fourier Transform (NUFFT), followed by a further transformation of the output of the first transformation using an inverse Fast Fourier Transform.

Use of the invention corrects the lack of spatial correlation allowing for simulation that is as accurate as using the Iso-range method but with the benefits of the Fixed-Earth method.

The method may further include scaling the range and Doppler shift values prior to resampling and integrating over all patches, to normalise range values so that the ambiguous range related to PRF is equal to 1, and the ambiguous Doppler related to PRF is equal to 1. The combination of using NUFFT with a scaling factor implements the range and Doppler aliasing inherent in pulse-Doppler radar.

Where implemented for a bistatic radar, the method may include calculating triplet values of reflected energy, range and Doppler shift for each discrete patch of the terrain model for a given position and pose of both non-co-located transmit antenna and a receive antenna within the global coordinate frame, each having known gain and phase characteristics.

The pulse-Doppler radar may be an airborne pulse-Doppler radar.

The terrain model may simulate one or more realistic and/or real-world terrain features. For example the terrain model may be generated by defining a fixed ground mesh by mapping digital real-world elevation map data to earth-centred earth-fixed coordinates. Alternatively the terrain may alternatively be randomly generated using, for example, Perlin noise.

In another aspect of the invention there is provided a method of performance testing a radar component, the method comprising: providing (which may comprise constructing) a computer model of the radar component [this may include selecting design parameters of the radar component, e.g. one or more of including antenna's gain characteristics; beam shape; PRF; operating frequency; type, number design of clutter filter(s)]; and simulating operation of the radar component by running the computer model of the radar component using, as an input to the computer model, simulated radar reflections from ground and/or sea clutter derived from the method of simulating radar reflections from ground and/or sea clutter for a pulse-Doppler radar described above.

The invention may also be expressed in apparatus terms and thus according to a further aspect of the invention there is provided a computer implemented reflection simulator to simulate radar reflections from ground clutter for a pulse-Doppler radar, the reflection simulator comprising:
a computer readable store holding a terrain model comprised from discrete flat ground patches each having a reflectance, area, surface normal vector, and position within a global coordinate frame, that are all independent of view point;
and one or more processors configured to perform the functions of a:
   a radar render configured to calculate triplet values of reflected energy, range and Doppler shift for each discrete patch of the terrain model for a given position and pose of an antenna with known gain and phase characteristics within the global coordinate frame; and
   a model calculator adapted to, for a given radar receiver sample rate and Pulse repetition frequency (PRF), resample and integrate over all patches to derive either:
i) energy within each discrete range-Doppler pair bin of a set defined by the PRF and sample rate; and/or
ii) receiver signal level at discrete time samples for each pulse;
characterised in that the resampling and integrating process carried out by the model calculator comprises carrying out a first 2D transformation of the triplet values using a NUFFT, followed by a further transformation of the output of the first transformation using an inverse FFT.

The model calculator may comprise a range-Doppler Resampler to derive the energy within each discrete range-Doppler pair bin of a set defined by the PRF and sample rate. The model calculator may comprise a Time-Domain Resampler to derive the receiver signal level at discrete time samples for each pulse.

The computer implemented reflection simulator may be incorporated with a radar test apparatus. Thus there may be provided a radar test apparatus comprising a signal generator adapted to generate signals derived from a specified ground clutter model generated by the model calculator of the computer implemented reflection simulator, so as to mimic the signal levels expected from ground clutter.

The invention may also find application for simulating synthetic aperture radar reflection and thus according to a further aspect of the invention there is provided a method of simulating synthetic aperture radar reflections for a pulse-Doppler radar, the method comprising:
a) providing a terrain model comprising discrete flat ground patches each having a reflectivity, area, surface normal vector, and position within a global coordinate frame, that are all independent of view point;
b) calculating triplet values of reflected energy, range and Doppler shift for each discrete patch of the terrain model for a given position and pose of an antenna with known gain and phase characteristics within the global coordinate frame;
c) for a given radar receiver sample rate and Pulse repetition frequency (PRF), resampling and integrating over all patches to derive either:
   i) energy within each discrete range-Doppler pair bin of a set defined by the PRF and sample rate; and/or
   ii) receiver signal level at discrete time samples for each pulse;
d) characterised in that the resampling and integrating process comprises carrying out a first 2D transformation of the triplet values using a non-uniform Fast Fourier Transform (NUFFT), followed by a further transformation of the output of the first transformation using an inverse Fast Fourier Transform.

The invention will now be described by way of example with reference to the following Figures in which:

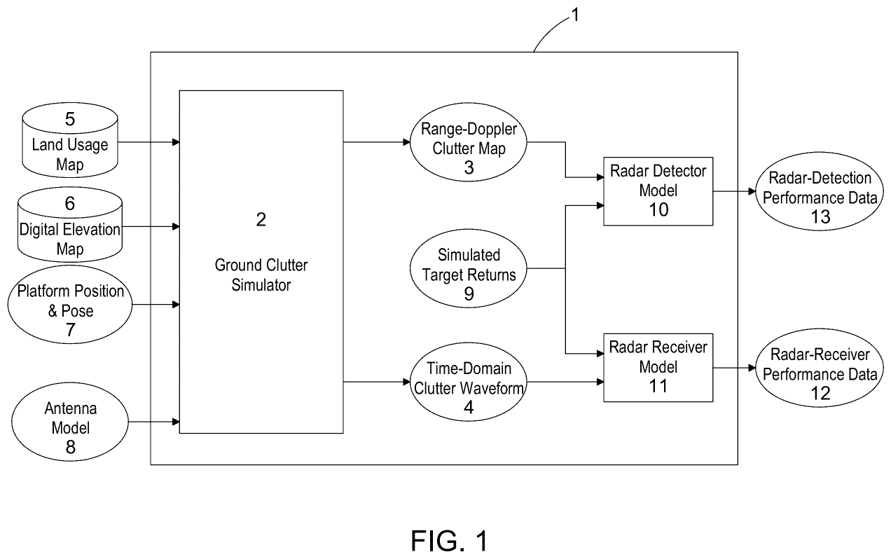

FIG. 1 is a schematic of a system for simulating target returns and ground clutter to test radar component performance;

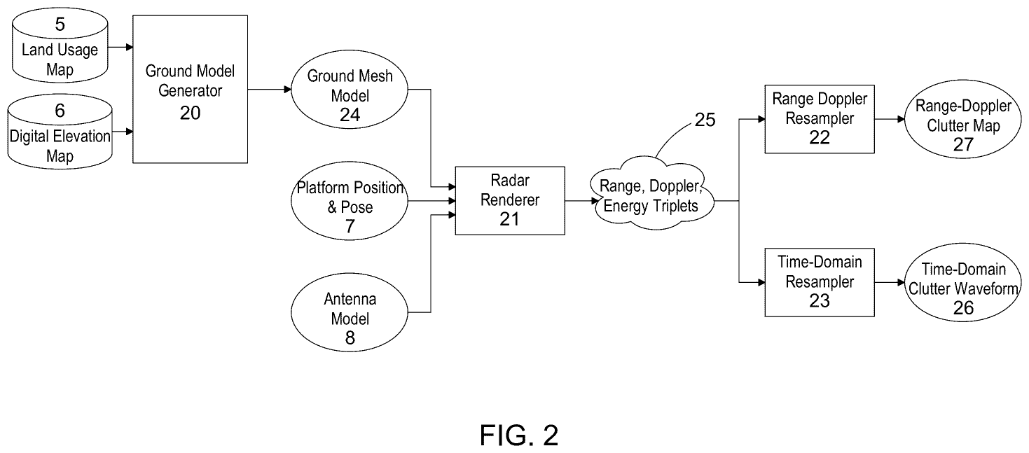

FIG. 2 is a schematic of the ground clutter simulator of FIG. 1;

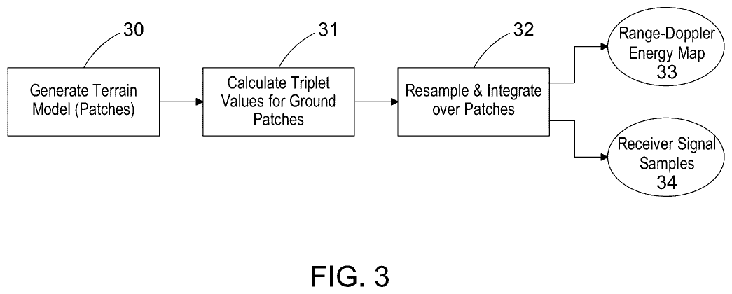

FIG. 3 illustrates process steps carried out by the ground clutter simulator;

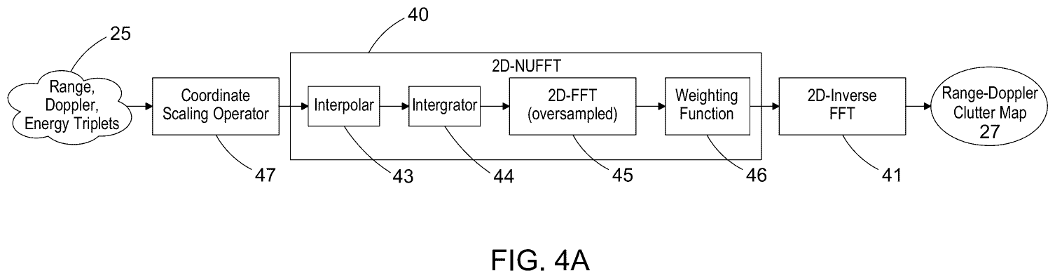

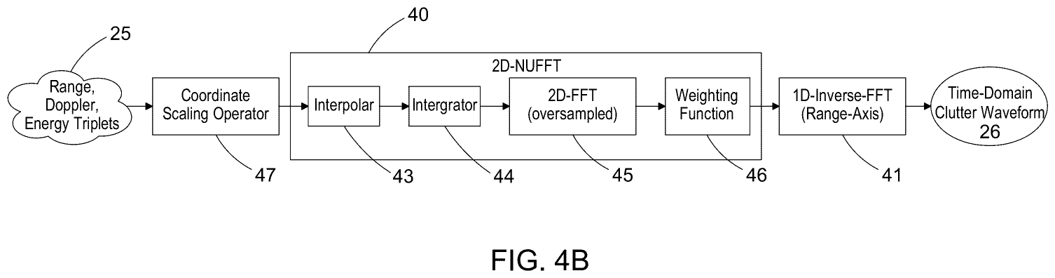

FIG. 4A illustrates the processing details carried out during resample and integrate processing step by the Range-Doppler Resampler; and

FIG. 4B illustrates the processing details carried out during resample and integrate processing step by the Time-Domain Resampler.

With reference to FIG. 1 there is shown a system 1 for simulating target returns and ground clutter for testing radar system components. The system 1 comprises a ground clutter simulator 2 adapted to output range-Doppler clutter maps 3 and/or Time-Domain clutter waveforms 4 based on terrain data in the form of land usage map(s) 5, digital elevations map(s) 6, platform position and pose information 7, and a model of the (or each where more than one) antenna's gain characteristics 8.

These simulated ground data can be used with simulations of potential target returns 9 to test or evaluate the performance of radar system components such a radar detector 10, radar receiver 11 (or computer models thereof, i.e. an emulated radar detector or emulated radar receiver) to measure radar performance metrics 12, 13.

FIG. 2 illustrates functional components of the ground clutter simulator 2. The ground clutter simulator 2 comprises a ground model generator 20, a radar renderer 21, a Range-Doppler resampler 22 and a Time-Domain Resampler 23.

FIG. 3 illustrates the method carried out by the ground clutter simulator 2. The ground model generator 20 generates a ground model {30}. The radar renderer 21 specialises the ground model to a specific radar, platform position and pose {31}. Finally, a resample and integration process {32} further specialises to a particular PRF expressed as either a range Doppler energy map 33 or a receiver signal samples 34 for a pulse train. This final stage can be repeated for different PRF bursts.

Returning to FIG. 2, the ground model generator 20 outputs a ground mesh model 24 comprised from contiguous triangular (triangular preferred but not essential) patches represented in a fixed global coordinate frame. Each patch has associated values of: reflectivity, area, surface normal vector and position within the global coordinate frame.

To generate the ground mesh model 24 the ground model generator 20 first defines a fixed ground mesh, which may be generated by mapping digital elevation map data to earth-centred earth-fixed coordinates, with aid of an Earth spheroid model or by using a Delaunay triangulation of a filter LiDAR point cloud data. The terrain may alternatively be randomly generated using, for example, Perlin noise. The ground model generator 20 applies a radar reflectivity value, y, to each ground patch. This may be achieved by incorporating land usage map data of terrain types, e.g. a from a third party source, in combination with a table associating terrain types with their reflectivity.

The area, surface normal vector and position of each patch may be determined as follows:
Let the vertices of a triangular ground patch have position vectors a, b, c in a global coordinate frame.
The centre of the patch y is:

$$y = ( a + b + c ) / 3$$

The area A is:

$$A = \vert a \times b + b \times c + c \times a \vert / 2$$

The patch vector normal n is:

$$n = ( a \times b + b \times c + c \times a ) / 2 A$$

The radar renderer 21 is configured to use the ground mesh model 24 together with given platform position and pose data 7, and an antenna gain model G 8 to calculate, for each patch in the ground mesh model 24, triplet values 25 of: reflected energy, range and Doppler shift.

The range is:

$$r = \vert x - y \vert$$

The patch displacement direction vector d is:

$$d = ( x - y ) / r$$

The elevation and azimuth angles as direction cosines u, v are:

$$u = cos θ sin ψ = i \cdot d \\ v = sin θ = j \cdot d$$

Where θ is the elevation angle and ψ is the azimuth angle. The grazing angle ϕ of the patch to an antenna beam is:

$$sin ϕ = n \cdot d$$

Together with the antenna gain model G and the transmitted energy Eₜ the radar equation, below, yields the reflected energy value.

$$E = \frac{{E}_{t} ρ sin ϕ {A}_{r} {G}^{2} ( θ , ψ )}{{( 4 π )}^{3} {r}^{4}}$$

And finally, the Doppler shift δf for carrier frequency f_{c}:

$$δ f = - \frac{2 {f}_{c}}{c} ( v \cdot d )$$

The output of the radar renderer 21 is a set of scalar triplets (r, δf, E) 25. These may be transformed and integrated to either time-domain triplets 26 of sample time t, pulse number k and energy E′ by the Time-Domain Resampler 23, or to range-Doppler maps 27 defined by triplets of range gate î, Doppler bin D and clutter energy Ê by the Range-Doppler Resampler 22.

The above applies to mono-static radar. The radar renderer 21 may be replaced with a variant for bi-static radar that employees two passes: an illumination pass and an observation pass. In the illumination pass the one-way radar equation is used to determine the energy at each patch due to the transmit antenna. The observation pass uses the one-way radar equation to determine the energy reflected to the observer. A reflection model that uses both illuminator and observer angles with the patch is applied.

With reference to FIG. 4A, the Range-Doppler Resampler 22 carries out first, a two-dimensional (2D) transformation of the triplet values 25 using a non-uniform Fast Fourier Transform (NUFFT) 40, followed by a further transformation of the output of the first transformation using a 2D inverse Fast Fourier Transform 41.

The 2D NUFFT 40 performs the functions of integration and resampling but the output is in a transform domain. The 2D inverse FFT functions to return the data to the starting domain of range and Doppler.

With reference to FIG. 4B, the Time Domain Resampler 23 carries out a first two-dimensional (2D) transformation of the triplet values 25 using a non-uniform Fast Fourier Transform (NUFFT) 40, followed by a further transformation of the output of the transformation using an 1D inverse Fast Fourier Transform 42 along the range dimension.

The NUFFT 40 is a computationally efficient way to implement a non-uniform discrete Fourier transform. A non-uniform discrete Fourier may be written:

$${ℱ}_{NM}^{′} \{ {x}_{t} , {n}_{t} , {m}_{t} \} \to X ( k , l ) \\ X ( k , l ) = {\sum }_{t} {x}_{t} {ω}_{N}^{{n}_{t} \cdot k} {ω}_{M}^{{m}_{t} \cdot l} \\ k ∈ [ 0 , N ) \\ l ∈ [ 0 , M ) \\ {x}_{t} ∈ ℂ , \\ \{ {n}_{t} , {m}_{t} \} ∈ ℝ , \\ \{ t , k , l , N , M \} ∈ ℕ \\ Where : \\ {ω}_{N} = {e}^{- 2 π i / N}$$

The NUFFT 40 implements the NUDFT as follows:
i) The input triplets 25 of value (energy) and two coordinates (range and Doppler) are resampled onto a regular grid of range-Doppler bins using a specified interpolation kernel function. This provides the interpolation function 43.
ii) The resampled values mapped to the same bin are summed. This provides the integration function 44.
iii) A regular 2D FFT is applied to all the range-Doppler bins 45.
iv) A 2D weighting function is element-wise multiplied 46 onto the bins. This function varies over the regular grid and is the same size as the regular grid.

Further detail of the implementation of the NUFFT may be found in J. A. Fessler, “On NUFFT-based gridding for non-Cartesian MRI,” Journal of magnetic resonance, vol. 188, no. 2, pp. 191-195, 2007, and K. Fourmont, “Non-equispaced fast Fourier transforms with applications to tomography,” Journal of Fourier Analysis and Applications, vol. 9, no. 5, pp. 431-450, 2003, with a Kaiser-Bessel function as its interpolator, and the extension described in P. J. Beatty, D. G. Nishimura and J. M. Pauly, “Rapid gridding reconstruction with a minimal oversampling ratio,” IEEE transactions on medical imaging, vol. 24, no. 6, pp. 799-808, 2005. for choosing sensible scale parameters for the interpolation kernel.

Prior to applying the NUFFT 40, the range and Doppler coordinate values of the triplets 25 may be scaled by a coordinate scaling operator 47. Starting with the previously computed ground patch triplet representation (rₜ, δfₜ, Eₜ), with unambiguous range and Doppler shift, render with the particular range and Doppler aliasing of a given PRF fᵣ by appropriate scaling. Let the number of pulses be Nₚ and the number of samples in the PRI be Mᵣ. Apply an NUFFT with output dimensions Nₚ by Mᵣ. The required coordinate scaling to mimic the PRF-induced aliasing is:

$${n}_{t} = δ {f}_{t} {N}_{p} / {f}_{r} \\ {m}_{t} = {r}_{t} {M}_{r} {f}_{r} / c$$

This has the effect of normalising the Doppler shift so that ambiguous Doppler shift is 1, and similarly the ambiguous range is 1.

We may now apply an Nₚ×Mᵣ dimensional NUFFT to these scaled triplets:

$$X ( k , l ) = {ℱ}_{{N}_{p} {M}_{r}}^{′} \{ {E}_{t} , {n}_{t} , {m}_{t} \}$$

Variations to the afore described example are possible. For example, in a variant embodiment the ground clutter simulator may comprise only one of the resamplers 22, 23.

The method described above can be used for simulating synthetic aperture radar (SAR) returns by repeating the process for multiple platform positions and poses spaced along a flight path.

Similarly, you can simulate a multi-burst dwell by repeating the resampler stage 22,23 with multiple different PRFs.

The ground clutter simulator 2 may be implemented by one or more processors programmed with suitable software. A typical combination of hardware and software could be a general-purpose computer system with a computer program that, when being loaded and executed, controls the computer system such that it carries out the methods described herein

Where used for evaluating performance of an emulated radar component (e.g. radar receiver or radar detector), the system 1 as a whole may be by one or more processors programmed with suitable software.

In one application, a computer model of the radar component is generated having a selected set of design parameters, said design parameters including, for example, antenna gain characteristics, PRF, frequency of operation, and one or more specific clutter filters. The model of the radar component is run, inputting data derived from a specified ground clutter model constructed by the afore describe system that mimic signals expected from ground clutter and simulated target returns. The output of the radar component model are outputted to a resource, e.g. printed or displayed on a computer visual display. The results can be used to determine whether (and if so how well) the target could be distinguished from the clutter. One or more of the design parameters of the emulated radar component may then be altered and the test repeated to identify differences in the radar system performance with the overall aim of improving the design of the radar component.

Where the system is used to performance test a physical radar component (as opposed to an emulated radar component) the system includes a signal generator, e.g. comprising a digital-analogue converter, having outputs connected to test signal input points on the radar component under test. The signal generator is adapted to generate (typically radio frequency) signals derived from a specified ground clutter model constructed by the afore describe system that mimic signals expected from ground clutter (and optionally also simulated target returns) to test the performance of the radar component. As with the emulated component, the testing may be repeated after altering one or more of the operating parameters of the radar component

As discussed above, the system can be used to simulate realistic (though not existing in the real world) ground clutter associated with one or more types of topographical relief, as well as to simulate ground clutter returns expected from real-world locations. The above description is directed to ground clutter simulation, however, the method can also be applied to simulate sea clutter.

Although conceived for the purpose of simulating ground clutter, the inventors realise that the method may also be applicable for simulating synthetic aperture radar reflections. As such the method may be used in the design and/or performance testing of synthetic aperture radar.

1-7. (canceled)

8. A computer implemented method of simulating radar reflections from ground and/or sea clutter for a pulse-Doppler radar, the method comprising:
a) providing a terrain model including discrete flat ground patches each having a reflectivity, area, surface normal vector, and position within a global coordinate frame, that are all independent of view point;
b) calculating triplet values of reflected energy, range and Doppler shift for each discrete patch of the terrain model for a given position and pose of an antenna with known gain and phase characteristics within the global coordinate frame;
c) for a given radar receiver sample rate and Pulse repetition frequency (PRF), resampling and integrating over all patches to derive:
i) energy within each discrete range-Doppler pair bin of a set defined by the PRF and sample rate; and/or
ii) receiver signal level at discrete time samples for each pulse; and
d) wherein the resampling and integrating process includes carrying out a first 2D transformation of the triplet values using a non-uniform Fast Fourier Transform (NUFFT), followed by a further transformation of an output of the first transformation using an inverse Fast Fourier Transform.

9. A method according to claim 8, comprising:
scaling the range and Doppler shift values prior to resampling and integrating over all patches, to normalise range values so that an ambiguous range related to PRF is equal to 1, and an ambiguous Doppler related to PRF is equal to 1.

10. A method according to claim 8, comprising:
calculating triplet values of reflected energy, range and Doppler shift for each discrete patch of the terrain model for a given position and pose of both non-co-located transmit antenna and a receive antenna within the global coordinate frame, each having known gain and phase characteristics.

11. A computer implemented reflection simulator to simulate radar reflections from ground and/or sea clutter for a pulse-Doppler radar, the reflection simulator comprising:
a computer readable store holding a terrain model configured from discrete flat ground patches each having a reflectance, area, surface normal vector, and position within a global coordinate frame, that are all independent of view point; and
one or more processors configured with software that when executed will cause the one or more processors to perform functions of:
a radar render configured to calculate triplet values of reflected energy, range and Doppler shift for each discrete patch of the terrain model for a given position and pose of an antenna with known gain and phase characteristics within the global coordinate frame; and
a model calculator configured and adapted to, for a given radar receiver sample rate and Pulse repetition frequency (PRF), resample and integrate over all patches to derive either:
i) energy within each discrete range-Doppler pair bin of a set defined by the PRF and sample rate; and/or
ii) receiver signal level at discrete time samples for each pulse;
wherein the resampling and integrating process when carried out by the model calculator will include carrying out a first 2D transformation of the triplet values using a NUFFT, followed by a further transformation of the output of the first transformation using an inverse FFT.

12. A computer implemented reflection simulator according to claim 11, in combination with a radar test apparatus comprising:
a signal generator configured and adapted to generate signals derived from a specified ground clutter model generated by the model calculator so as to mimic signal levels expected from ground clutter.

13. A method of simulating synthetic aperture radar reflections for a pulse-Doppler radar, the method comprising:
a) providing a terrain model comprising discrete flat ground patches each having a reflectivity, area, surface normal vector, and position within a global coordinate frame, that are all independent of view point;
b) calculating triplet values of reflected energy, range and Doppler shift for each discrete patch of the terrain model for a given position and pose of an antenna with known gain and phase characteristics within the global coordinate frame;
c) for a given radar receiver sample rate and Pulse repetition frequency (PRF), resampling and integrating over all patches to derive either:
i) energy within each discrete range-Doppler pair bin of a set defined by the PRF and sample rate; and/or
ii) receiver signal level at discrete time samples for each pulse; and
d) wherein the resampling and integrating process includes carrying out a first 2D transformation of the triplet values using a non-uniform Fast Fourier Transform (NUFFT), followed by a further transformation of the output of the first transformation using an inverse Fast Fourier Transform.

14. A method according to claim 8, implemented for performance testing a radar component, the method comprising:
providing a computer model of the radar component; and simulating operation of the radar component by running the computer model of the radar component using, as an input to the computer model, simulated radar reflections from ground and/or sea clutter derived from the simulating of radar reflections from ground and/or sea clutter for a pulse-Doppler radar.
